(19) United States
(12) Patent Application Publication
(10) Pub. No.: US 2016/0094391 A1
(43) Pub. Date: Mar. 31, 2016

(54) AUTOMATED COMPUTING SYSTEM PERSONALIZATION

(71) Applicant: Microsoft Corporation, Redmond, WA (US)

(72) Inventors: Bahram Bahram Pour, Woodinville, WA (US); Stephen Wald, Seattle, WA (US)

(21) Appl. No.: 14/502,889

(22) Filed: Sep. 30, 2014

(51) Int. Cl. H04L 12/24; H04L 29/08

(52) U.S. Cl. CPC H04L 41/0816; H04L 67/10

(57) ABSTRACT

The personalization of the functionality of a computing system. In response to identifying the user to personalize its functionality to, the computing system self-personalizes by automatically requesting personalization information for the identified user from a remote personalization engine. The resulting received personalized information is then applied to the computing system to at least partially personalize the functionality of the computing system to the identified user.

### BACKGROUND

Often, a user may encounter a computing system or device (collectively referred to simply as a “computing device”) that the user has never worked with before. This can be a somewhat awkward experience for the user since the new computing system is not personalized to the user. On the other hand, when the user works on a device that the user has often worked with before, the user might have applied a number of personalization settings to the familiar computing system. Such personalization gives the user a greater level of comfort with the computing system, but such comfort is no longer there when encountering a new device.

For instance, when the user purchases a new computing system or device, the user often must go through the process of personalizing the new computing device if similar comfort is desired. This can take significant time, and often it is not clear how to personalize the new computing system to match the personalization of the user's previous or more familiar device. In another scenario, when a user enters a store to purchase a computing system, the user often wants to interact with a computing system that might be purchased to evaluate whether the customer is comfortable with the computing system. However, such store shelf computing systems often have default settings and/or are not personalized to the user. Accordingly, it may be difficult for the user to truly evaluate how the user will feel about the computing system after purchase and once the computing device is personalized.

The subject matter claimed herein is not limited to embodiments that solve any disadvantages or that operate only in environments such as those described above.

Rather, this background is only provided to illustrate one exemplary technology area where some embodiments described herein may be practiced.

### BRIEF SUMMARY

At least some embodiments described herein relate to the personalization of the functionality of a computing system. In response to identifying the user to personalize its functionality to, the computing system self-personalizes by automatically requesting personalization information for the identified user from a remote personalization engine. The resulting received personalize information is then applied to the computing system to at least partially personalize the functionality of the computing system to the identified user.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a network environment in which the principles described herein may operate, and which includes a computing system that is to be personalized to a user using personalization engines and potentially a seed device;

FIG. 3 illustrates a flowchart of a method for personalizing functionality of a computing system;

FIG. 4 illustrates a flowchart of a method for identifying a user and/or obtaining initial personalization information using a seed device; and

FIG. 5 illustrates a flowchart of a method for facilitating transient personalization.

### DETAILED DESCRIPTION

At least some embodiments described herein relate to the personalization of the functionality of a computing system. In response to identifying the user to personalize its functionality to, the computing system self-personalizes by automatically requesting personalization information for the identified user from a remote personalization engine. The resulting received personalize information is then applied to the computing system to at least partially personalize the functionality of the computing system to the identified user. Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Computing systems are now increasingly taking a wide variety of forms. Computing systems may, for example, be handheld devices, wearables, implants, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

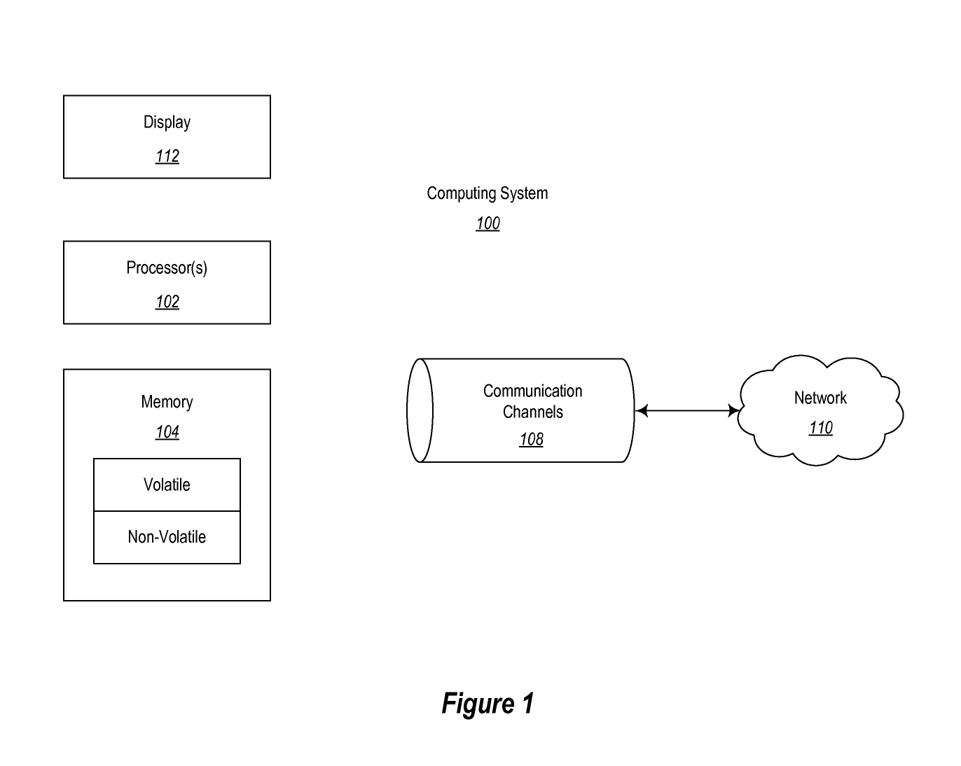

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 may also have a display 112 for displaying to a user.

Embodiments described herein may comprise or utilize a special-purpose or general-purpose computer system that includes computer hardware, such as, for example, one or more processors and system memory, as discussed in greater detail below. The system memory may be included within the overall memory 104. The system memory may also be referred to as “main memory”, and includes memory locations that are addressable by at least one processing unit 102 over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless (e.g., a single wireless link or multiple wireless links), or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links (e.g., a single wireless link or multiple wireless links), or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

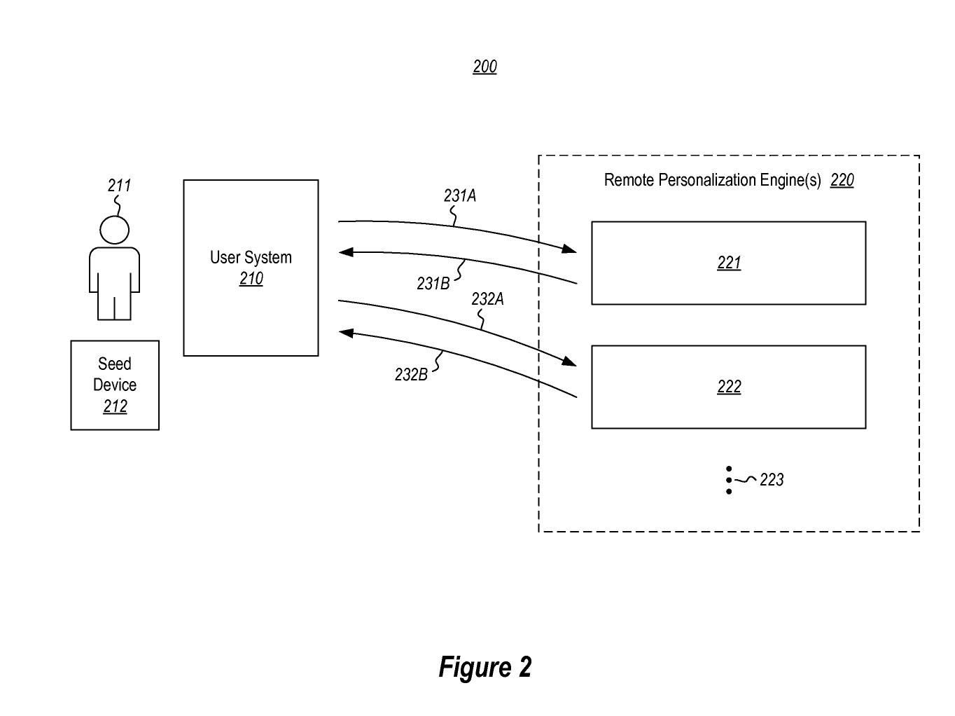

FIG. 2 illustrates a network environment 200 in which the principles described herein may operate. The network environment 200 includes a computing system 210 that is to be personalized to a user 211 and personalization engine(s) 220. Although the user 211 may be proximate the computing system 210 within the network environment 200, that need not be the case. Nevertheless, in accordance with the principles described herein, once the computing system 210 identifies a user that the computing system 210 is to personalize to, the computing system 210 automatically personalizes to the identified user 211 by obtaining associated personalization information from one or more of the personalization engine(s) 220. In some embodiments, the network environment 200 also includes a seed device 212 for purposes of at least identifying the user 211 to the computing system, and potentially identifying and locating personalization engine(s) 220.

Once the computing system 210 begins the personalization to the user 211 (by first identifying that the computing system 210 is to personalize to the user 211), the computing system may then be considered a “user system”. In other words, the mission of the computing system 210 is to become personalized to the user 211, and that will be the ultimate result. Accordingly, the computing system 210 may also be referred to as a user system 210 after the computing system 210 initiates the personalization.

The personalization engine(s) includes one or more personalization engines. For instance, although two personalization engine 221 and 222 are shown amongst the remote personalization engine(s) 220, the personalization engine(s) 220 may also include just one personalization engine, or three of more personalization engines. This generality and flexibility in the number of personalization engines 222 is represented by the ellipses 223.

In the described embodiment, the personalization engine 221 is a “remote” personalization engine, although there is no requirement that the additional personalization engine 222, if present, or any further personalization engines, if any, also be remote. The “remote” personalization engine 221 is “remote” in the sense that the personalization engine 221 is distant enough from the computing system 210 so as not to be able to establish a direct peer-to-peer connection without the assistance of additional network equipment. The remote personalization engine 221 may also be referred to as simply “personalization engine” (without the modifier “remote”), although the personalization engine 221 will be understood to be remote from the computing system 210 as the term “remote” has been defined herein.

The computing system 210 may be structured and function as described above for the computing system 100 of FIG. 1. The remote personalization engine 221 may be a software component running remotely from the computing system 210. In that case, the remote personalization engine 221 may operate upon a computing system such as the computing system 100 of FIG. 1. Also, the remote personalization engine 221 may itself be structured as a computing system itself, in which case the remote personalization engine 221 may be an example of the computing system 100 of FIG. 1. The remote personalization engine 221 might operate, for instance, on a server, a server cluster, or a cloud computing environment.

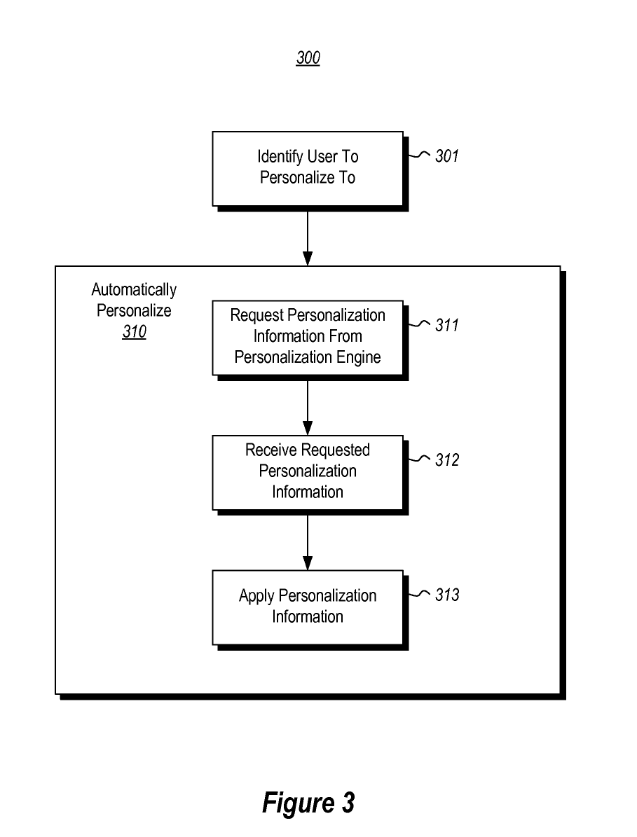

FIG. 3 illustrates a flowchart of a method 300 for personalizing functionality of a computing system. The method 300 may be performed by, for instance, the computing system 210 of FIG. 2. Accordingly, the method 300 of FIG. 3 will now be described with frequent reference to the environment 200 of FIG. 2.

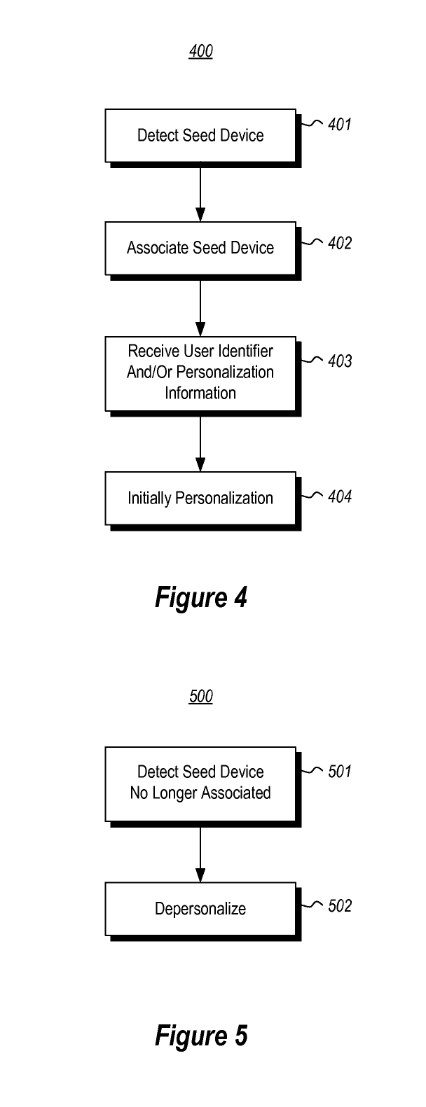

The method 300 in initiated upon a computing system identifying a user to personalize functionality of the computing system to (act 301). For instance, in FIG. 2, the computing system 210 might identify that the computing system 210 is to personalize to the user 211. For instance, a user might identify themselves the computing system 210 by providing user-entered self-identification data. Alternatively, the computing system 210 might identify the user 211 as the target of personalization through the presences of the seed device 212. An example of how the seed device 212 might be used to do this will be described further below with respect to FIG. 4.

In response to identifying the user (act 301), the computing system automatically personalizes to that user (act 310) using personalization information received from one or more personalization engines. For instance, the computing system 210 automatically personalizes to the user 211 using information received from the remote personalization engine 221. If there is more than one personalization engine 220, the computing system 210 also uses information received from the remote personalization engine 222, as well as potentially one or more additional personalization engines. Accordingly the acts shown within the automatic personalization act 310 may be performed for each of the one or more personalization engines from which personalization information is received.

In some cases, identification of the user itself may be sufficient to identify any available personalization engine(s) for that user. Alternatively or in addition, the seed device 212 might provide additional information from which the computing system 210 might identify and locate the personalization engine(s) 220 and otherwise properly formulate and dispatch requests for personalization information.

Specifically, for each personalization engine, the computing system to be personalized (i.e., the user system) automatically requests personalization information for the identified user from the personalize engine (act 311). For instance, in FIG. 2, the computing system 210 requests (as represented by arrow 231A) personalization information for the identified user 211 from the remote personalization engine 221. If the personalization engine 222 were present, then the computing system 210 would also request (as represented by arrow 232A) personalization information for the identified user 211 from the remote personalization engine 222 (as represented by arrow 232A), and likewise for any further present personalization engine that might have personalization information corresponding to the user 211.

In response to the request for personalization information made to a given personalization engine, the computing system receives at least some of the requested personalization information from that given personalization engine (act 312). For instance, in FIG. 2, the computing system 210 receives personalization information from the remote personalization engine 221 as represented by the arrow 231B. If the personalization engine 222 were present, and if the computing system 210 requested personalization information for the user 211 from that personalization engine, then the computing system 210 might likewise receive personalization information from the personalization engine 222 (as represented by arrow 232B), and likewise for any additional personalization engines that might have been targets of such requests.

The computing system then applies at least some of the received personalization information to the computing system thereby at least partially personalizing the functionality of the computing system to the identified user (act 313). For instance, in FIG. 2, the computing system 210 applies the personalization information received from the remote personalization engine 221 to the computing system 210, thereby automatically at least partially personalizing the computing system 210 to the user 211. If there is a personalization engine 222 and that personalization engine 222 also responded with personalization information, then that received personalization information might also be applied (act 313), and likewise for any personalization information received from any personalization engines.

In some embodiments, the different personalization engines 220 act as personalization sources for different trust levels. For instance, the first personalization engine 221 might act as a personalization source for one trust level, whilst another personalization engine 222 acts as a personalization source for yet another trust level. For instance, certain personalization settings or files might be more sensitive than others. For instance, autocomplete settings might be deemed to have a different sensitivity level as compared to, for instance, tile layout settings. The different trust levels might be accomplished by, for instance, user creation of trust (e.g., entering a user name and password), or by automated creation of trust. For instance, the seed device might have certificates required to automatically set up a trust level required between the personalization engine, the computing system and the user.

FIG. 4 illustrates a flowchart of a method 400 for identifying the user and/or setting up initial personalization settings. The computing system detects the presence of a seed device (act 401), and then associates the seed device with the computing system (act 402).

For instance, in FIG. 2, the user 211 might be carrying the seed device 212. The user 211 might then perform some action that allows the seed device 212 and the computing system 210 to communicate. As an example, the seed device 212 might be contact device that is plugged into computing system 210 so as to allow the computing system 210 and the seed device 212 to communicate over a wired connection. Another type of contact device is a tap device that is tapped on the computing system 210 so as to allow the computing system 210 and the seed device 212 to communicate over a wireless link. The seed device 212 might also be brought into close proximity to the computing system 210 such that the computing system 210 and the seed device 212 wirelessly communicate.

The computing system 210 and/or the seed device 212 might optionally impose other conditions prior to making the association (act 402). For instance, such a condition might include the user 211 activating a control on the seed device 212, and/or that the seed device 212 be within positional relationship with respect to the computing system 210 (e.g., be within a certain distance, or perhaps in front of the display of the computing system) and so forth. Such conditions, if any, might be designed to make it more likely that the user intends to use the seed device 212 to personalize the computing system 210.

After association (act 402), the computing system 210 then receives data (act 403) from the seed device 212. As an example the data might include information identifying the user 211, identification and/or location information for the personalization engine(s) 220, or any other information helpful for the computing system 210 in performing the method 300 of FIG. 3. In that case, the receipt of such data represents an example of how the act of identifying the user (act 201) of FIG. 2 may occur.

The data might also include initial personalization information that may be used to personalize the computing system 210 even prior to the computing system 210 receiving personalization information from any of the personalization engine(s) 220. For instance, the user might be able to have rapid personalization in some areas whilst still awaiting other personalization to be completed. In the case of the seed device 212 providing such initial personalization information, the method 400 may also include initially personalizing (act 404) the computing system. That initial personalization may be separate and apart from the later personalization that occurs in act 213 of method 200. As an example, the initial personalization information might be desktop configuration information, background information, usage history, a schema definition, or any other type of personalization information.

In some embodiments, the personalization might be highly transient. For example, suppose that a user were to walk into an electronics store desiring to test a number of electronic devices prior to purchase. The user might walk up to an electronic device, and within a few seconds, personalization is in process and perhaps complete. Then the user walks away from that electronic device. The electronic device may then revert back to its prior settings. Accordingly, the personalization may be quite transient.

FIG. 5 illustrates a flowchart of a method 500 for facilitating transient personalization. The method 500 may be performed after, for instance, the method 300 of FIG. 3 (in the case of personalization via the user of the personalization engine(s) 220, or even after just the method 400 is complete in the case of the electronic device just having initial personalization via the user of the seed device 212.

The method 500 is initiated upon the computing system 210 detecting that the seed device is no longer in association with the computing system (act 501). For instance, the seed device 212 might have moved away from the computing system 210. Alternatively or in addition, one or more conditions for the association between the seed device 212 and the computing system 210 might no longer be satisfied, and/or or one or more conditions for disassociating the seed device 212 and the computing system 210 might be satisfied. As an example of a disassociating condition, perhaps there is a disassociation control on the seed device 212 that the user 211 may select to explicitly cause the seed device 212 to request that the computing system 210 disassociate. Once the computing system 210 disassociates, the computing system 210 automatically depersonalizes (act 402) by, for example, reverting to the prior settings that existed prior to personalization.

Thus, a user might wander from one electronics device to the next within an electronics store, and evaluate the look and feel of each electronic device as personalized to that specific user. Other customers within the same store might likewise have the same experience. For each customer, it would as though the store was set up with electronic devices that were personalized for each user specifically.

Accordingly, the principles described herein allow devices and systems to be automatically personalized to a user. In transient personalization embodiments, the devices and systems might likewise be depersonalized automatically.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for personalizing functionality of a computing system, the method comprising:
an act of identifying a user to personalize functionality of a computing system to; and
an act of the computing system automatically responding to the act of identifying the user by performing the following:
an act of requesting personalization information for the identified user from a remote personalization engine;
an act of receiving at least some of the requested personalization information from the remote personalization engine; and
an act of apply at least some of the received personalization information to the computing system thereby at least partially personalizing the functionality of the computing system to the identified user.

2. The method in accordance with claim 1, the remote personalization engine being a first personalization engine, the act of the computing system automatically responding to the act of identifying by further automatically performing the following:
an act of requesting personalization information for the identified user from a second personalization engine;
an act of receiving at least some of the requested personalization information from the second personalization engine; and
an act of apply at least some of the received personalization information from the second personalization engine to the computing system.

3. The method in accordance with claim 2, the first personalization engine acting as a personalization source of a first trust level, the second personalization engine acting as a personalization source of a second trust level.

4. The method in accordance with claim 3, the first trust level being accomplished through user creation of trust.

5. The method in accordance with claim 2, the received personalization information from the first personalization engine for personalizing a first set of resources of the computing system, the received personalization information from the second personalization engine for personalizing a second set of resources of the computing system.

6. The method in accordance with claim 1, the act of identifying a user to personalize functionality of a computing system to comprising:
an act of interpreting user-entered self-identification data.

7. The method in accordance with claim 1, the act of identifying a user to personalize functionality of a computing system to comprising:
an act of associating a seed device with the computing system, the seed device being proximate the computing system; and
an act of receiving data from a seed device that is proximate the computing system.

8. The method in accordance with claim 7, the data received from the seed device over a wireless connection.

9. The method in accordance with claim 7, the seed device being a contact device that physically contacts the computing system thereby transferring the received data to the computing system.

10. The method in accordance with claim 7, the seed device having personalization settings, at least some of which to be applied to the computing system in the act of applying at least some of the received personalization information from the second personalization engine to the computing system.

11. The method in accordance with claim 7, further comprising:
an act of detecting that the seed device is no longer in associated with the computing system; and
in response to the act of detecting that the seed device is no longer in communication with the computing system, an act of automatically depersonalizing the computing system from the identified user.

12. The method in accordance with claim 11, the act of detecting that the seed device is no longer in associated with the computing system being performed in response to an act of detecting that the seed device is no longer proximate the computing system.

13. The method in accordance with claim 11, the act of detecting that the seed device is no longer in associated with the computing system being performed in response to an act of receiving a request from the seed device to disassociate the seed device and the computing system.

14. The method in accordance with claim 7, the received seed data also including initial personalization data, the method further comprising:
an act of personalizing the computing system using the initial personalization data even before receiving personalization data from the remote personalization engine.

15. The method in accordance with claim 14, the initial personalization data comprising desktop configuration information.

16. The method in accordance with claim 14, the initial personalization data comprising background information.

17. The method in accordance with claim 14, the initial personalization data comprising application usage history.

18. The method in accordance with claim 14, the initial personalization data comprising a schema identification.

19. A computer program product comprising one or more computer-readable storage media having thereon computer-executable instructions that are structured such that, when executed by one or more processors of a computing system, cause the computing system to perform the following in response to identifying a user to personalize to:
an act of requesting personalization information for the identified user from a remote personalization engine;
an act of receiving at least some of the requested personalization information from the remote personalization engine; and
an act of apply at least some of the received personalization information to the computing system thereby at least partially personalizing the computing system to the identified user.

20. A computing system comprising:
one or more processors;
one or more computer-storage media having thereon one or more computer-readable storage media having thereon computer-executable instructions that are structured such that, when executed by one or more processors of a computing system, cause the computing system to perform the following in response to identifying a user to personalize to:
an act of requesting personalization information for the identified user from a remote personalization engine;
an act of receiving at least some of the requested personalization information from the remote personalization engine; and
an act of apply at least some of the received personalization information to the computing system thereby at least partially personalizing the functionality of a computing system to the identified user.
